(19) United States
(12) Patent Application Publication
(10) Pub. No.: US 2025/0269631 A1
(43) Pub. Date: Aug. 28, 2025

(54) RECYCLABLE PACKAGE WITH FITMENT

(71) Applicant: NOVA Chemicals (International) S.A., Fribourg (CH)

(72) Inventors: Vinod Konaganti, Calgary (CA); Ian Gibbons, Calgary (CA); Amin Mirzadeh, Calgary (CA); Robert Clare, Cochrane (CA); Gilbert Arnould, Calgary (CA); Anoop Dhaliwal, Calgary (CA); Shivendra Goyal, Calgary (CA); Mehrnaz Rahimi, Calgary (CA); Stephen Brown, Calgary (CA)

(73) Assignee: NOVA Chemicals (International) S.A., Fribourg (CH)

(21) Appl. No.: 18/279,670

(22) PCT Filed: Mar. 8, 2022
(86) PCT No.: PCT/IB2022/052055

§ 371 Date: Aug. 31, 2023

Related U.S. Application Data
(60) Provisional application No. 63/159,265, filed on Mar. 10, 2021.

(51) Int. Cl. B32B 27/08; B29C 48/00; B29C 48/08; B29C 48/21; B29K 23/00; B29L 7/00; B32B 7/12; B32B 27/32; B32B 37/06; B32B 37/10; B32B 37/16

(52) U.S. Cl. CPC B32B 27/08; B29C 48/022; B29C 48/08; B29C 48/21; B32B 7/12; B32B 27/327; B32B 37/06; B32B 37/10; B32B 37/16; B29K 2023/0616; B29K 2023/0625; B29K 2023/065; B29K 2995/0063; B29L 2007/008; B32B 2250/242; B32B 2307/31; B32B 2307/72; B32B 2309/02; B32B 2309/04; B32B 2309/12; B32B 2323/043; B32B 2323/046; B32B 2439/00

(57) ABSTRACT

A flexible package includes a multilayer film including a first skin layer comprising a high density polyethylene having a density of about 0.950 g/cm³ to about 0.970 g/cm3 and a melt index, I₂, of about 0.5/10 minutes to 10 g/10 minutes, a core layer comprising polyethylene, and a second skin layer comprising a sealant polyethylene having a molecular weight distribution Mw/Mn of 2 to 4, a density of 0.880 g/cm³ to 0.920 g/cm³, and a melt index, I₂, of 0.3 g/10 minutes to 5 g/10 minutes; wherein the multilayer film is at least 90 wt. % polyethylene: and a fitment that includes an ethylene-alpha-olefin co-polymer having a density of 0.880 g/cm³ to 0.930 g/cm³.

### CROSS-REFERENCE TO RELATED APPLICATIONS

This application is a U.S. National Phase Application under 35 U.S.C. 371 of International Patent Application No. PCT/IB2022/052055, filed on Mar. 8, 2022, which in turn claims the benefit of priority to U.S. Provisional Application No. 63/159,265 filed on Mar. 10, 2021, the entire contents of both of which are hereby incorporated by reference.

### TECHNICAL FIELD

The present technology is generally related to flexible packaging. More specifically, the technology is directed to flexible packaging having a fitment, where the packaging and fitment include polyethylene.

### BACKGROUND ART

It is known to prepare flexible packages having integral fitments (such as spouts or valves). The fitments may be installed using an adhesive or using heat sealing. The amount of heat required to heat seal the flexible film to the fitment is significant, and, as a result, the flexible film typically contains at least one layer of a heat resistant polymer (such as polyamide or polyester) to ensure that the film does not fail during the welding process. This makes these packages difficult to recycle because it is not possible to readily separate the polyester (or polyamide) layer from the polyethylene in current recycling facilities.

Conventional pouches with fitments are typically made with a multilayer film (polyester and polyethylene) that is heat sealed to a fitment made from high density polyethylene (HDPE) or polypropylene (PP). These packages are difficult to recycle because of the different materials of construction (PET+PE). It is also known that heat sealing films to fitments made from HDPE or PP on a conventional packaging machine can show poor seals and/or “burn through” resulting from physical deterioration of the film structure in response to extended heating and melting. Use of fitments made from HDPE or PP is typically limited for films where the sealant layer is of a similar density to limit burn through while providing a stronger seal. What is needed is a compatible combination of a multilayer film and fitment, each composed mainly of polyethylene, that provides high seal quality and can be used to prepare flexible packaging that is more amenable to recycling.

### SUMMARY OF INVENTION

In one aspect, the present disclosure relates to a flexible package that includes a multilayer film and a fitment, where the multilayer film is at least about 90 wt. % polyethylene and includes a first skin layer of a high density polyethylene having a density of about 0.950 g/cm³ to about 0.970 g/cm³ and a melt index, I₂, of about 0.5 g/10 minutes to about 10 g/10 minutes, a core layer comprising polyethylene, and a second skin layer of a sealant polyethylene having a molecular weight distribution Mw/Mn of about 2 to about 4, a density of about 0.88 g/cm³ to about 0.92 g/cm³, and a melt index, I₂, of about 0.3 g/10 minutes to about 5 g/10 minutes, and where the fitment includes an ethylene-alpha-olefin co-polymer having a density of about 0.880 g/cm³ to about 0.910 g/cm³.

In another aspect, the present disclosure relates to a flexible package that includes a multilayer film and a fitment, where the multilayer film is at least about 90 wt. % polyethylene and includes: a first skin layer of a high density polyethylene having a density of about 0.950 g/cm³ to about 0.970 g/cm³ and a melt index, I₂, of about 0.5 g/10 minutes to about 10 g/10 minutes, a core layer comprising polyethylene, and a second skin layer of a sealant polyethylene having a molecular weight distribution Mw/Mn of about 2 to about 4, a density of about 0.88 g/cm³ to about 0.92 g/cm³, and a melt index, I₂, of about 0.3 g/10 minutes to about 5 g/10 minutes; and where the fitment includes a blend of any two or more of a linear low density polyethylene, a very low density polyethylene, and a plastomer, and has a density of about 0.920 g/cm³ or less and a melt index, I₂, of about 5 g/10 minutes or greater.

In another aspect, the present disclosure relates to a process of making a flexible package having a sealed fitment, the process including heat sealing the fitment to the multilayer film to form the flexible package. In any such embodiments, the heat sealing may include applying a heated pressure bar, one or more times, to the fitment at a pressure from about 15 psi to 50 psi, at a temperature of 120° C. to 180° C., and for a dwell time of less than 3 seconds.

### BRIEF DESCRIPTION OF DRAWINGS

FIG. 1 is a graph of seal strength values for seals formed between test film-1 and various proxy fitments at a seal bar temperature of 160° C., a pressure of 40 psi, and dwell times of 1.5 and 2.5 seconds, according to the examples.

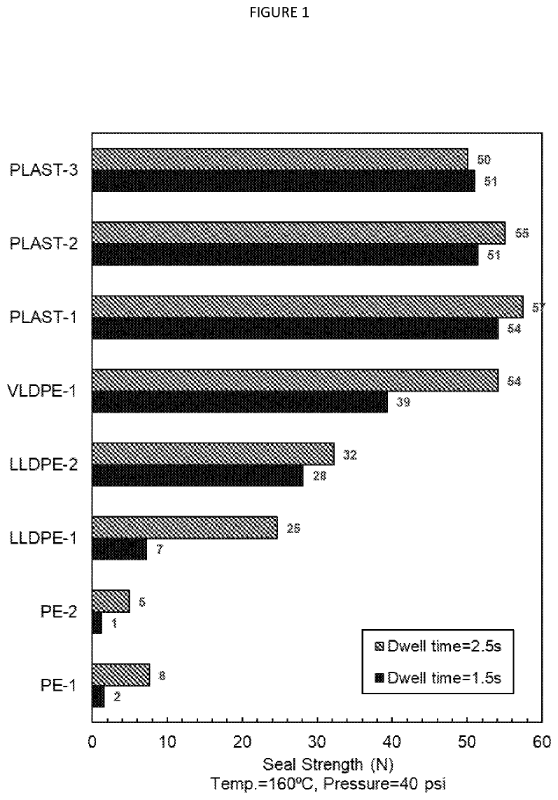

FIG. 2 is a graph of seal strength values for seals formed between test film-1 and various proxy fitments at a seal bar temperature of 165° C., a pressure of 20 psi, and dwell times of 1.5, 2, and 2.5 seconds, according to the examples.

FIG. 3 is a graph of seal strength values for seals formed between test film-1 and various proxy fitments at a seal bar temperature of 170° C., a pressure of 40 psi, and dwell times of 1.5, 2, and 2.5 seconds, according to the examples.

FIG. 4 is a graph of surface hardness values (Shore D and Shore A) of various proxy fitments.

FIG. 5 is a graph of flexural secant modulus (1%) and flexural yield strength values of various proxy fitments.

### DESCRIPTION OF EMBODIMENTS

Provided herein is a flexible package comprised of two parts: a multilayer film and a fitment. The multilayer film comprises three layers, including a first skin layer comprising a high density polyethylene, a core layer comprising a polyethylene, and a second skin layer comprising a sealant polyethylene. The fitment may comprise a very low density polyethylene, plastomer, or blends thereof. Alternatively, the fitment may comprise a blend of a very low density polyethylene or plastomer with a linear low density polyethylene. The multilayer films and fitments as described herein show very good sealing properties and provide an excellent combination for use in flexible package applications. Sealing can be accomplished using lower seal temperatures and at shorter seal times compared to film and fitment combinations with higher density polyethylenes.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate the embodiments and does not pose a limitation on the scope of the claims unless otherwise stated. No language in the specification should be construed as indicating any non-claimed element as essential.

As is understood in the art high density polyethylene (“HDPE”), medium density polyethylene (“MDPE”), linear low density polyethylene (“LLDPE”), very low density polyethylene (“VLDPE”), polyethylene plastomers (“plastomers”), and polyethylene elastomers (“elastomers”), all have density ranges that, while distinguishable to a certain extent in the art, also overlap at the extremes, and specific ranges may or may not be entirely indicative of one over the other. Such an understanding is also applicable to the use of such terms here. However, where necessary to define a density range for each, and while they may overlap to some extents, the following ranges may be identified: HDPE may refer to a polyethylene having a density of about 0.950 g/cm³ to about 0.970 g/cm³; MDPE may refer to a polyethylene having a density of about 0.930 g/cm³ to about 0.950 g/cm³; LLDPE may refer to a polyethylene having more branching than MDPE and having a density of about 0.910 g/cm³ to about 0.930 g/cm³; VLDPE may refer to a polyethylene having significant branching and having a density of about 0.905 g/cm³ to about 0.910 g/cm³; plastomer(s) may refer to a polyethylene having excessive branching having a density of about 0.880 g/cm³ to about 0.905 g/cm³; elastomer(s) may refer to a polyethylene having a density of about 0.857 g/cm³ to about 0.880 g/cm³.

As used herein a sealant polyethylene refers to a polyethylene material that is suitable for the preparation of a heat formed seal, for example a polyethylene selected from a polyethylene copolymer having a density of about 0.880 to 0.920 g/cm³. The sealant polyethylene may also have a melt index, I₂, of about 0.3 g/10 minutes to about 5 g/10 minutes, or for example about 0.3 g/10 minutes to about 3 g/10 minutes.

### Overview

The packages of this disclosure include two components, namely a multilayer polyethylene film (described in Part A, below), and a fitment comprising a VLDPE, plastomer, or blends thereof. Alternatively, the fitment may comprise a blend of a VLDPE or plastomer with an LLDPE (described in Part B, below). In some embodiments, the fitment is made from a polyethylene plastomer. In other embodiments, the fitment is made from a VLDPE. In other embodiments, the fitment is made from a blend of a VLDPE or a plastomer with an LLDPE. In other embodiments, the fitment is made from a blend of a VLDPE, a plastomer, and an LLDPE. Such packages are amenable to recycling, with the problems described above. According to some embodiments, the packages are recyclable flexible packages with an integral soft touch fitment that is prepared from about 90 to about 100% polyethylene by weight.

In some embodiments, flexible packages having integral fitments (such as spouts or valves) that can be installed using heat sealing and such fitments are made using soft touch polyethylene plastomers or VLDPE resins having a density of about 0.880 to about 0.910 g/cm³ and melt index (measuring using a load of 2.16 kg at 190° C.) of about 3 g/10 minutes to about 40 g/10 minutes. The ethylene-alpha-olefin copolymers used for making the fitments tend to exhibit a uniform and continuous melting distribution that leads to very high seal strength values for the seals formed between the multilayer film and the fitment substrate. In some embodiments, the ethylene-alpha-olefin copolymer compositions are provided that are suitable for making the soft touch fitments to be used in recyclable polyethylene based flexible packages.

In other embodiments, the integral fitments for the packages are made using a blend of a VLDPE and/or a plastomer, with an LLDPE having a density of less than about 0.920g/cm³ and melt index (measuring using a load of 2.16 kg at 190° C.) of about 5 g/10 minutes or greater. Thus, it may be a blend of VLDPE and LLDPE, a blend of plastomer and LLDPE, or a blend of VLDPE, plastomer, and LLDPE. In some embodiments, the blend exhibits a density of about 0.880 g/cm³ to about 0.920 g/cm³ and melt index, 12, of about 5 g/10 minutes to 50 g/10 minutes. Such blends include about 5 wt. % to about 50 wt. % of the VLDPE with the balance being plastomer, LLDPE, or a blend thereof. In some embodiments, the blend has a melt index of about 5 g/10 minutes or greater, a melt index of about 7 g/10 minutes or greater, about 10 g/10 minutes or greater; about 15 g/10 minutes or greater; or about 20 g/10 minutes or greater.

### Part A—the Multilayer Film

As noted above, the recyclable, flexible packing includes a multilayer film. The multilayer films include at least a first skin layer, a second skin layer, and core layer between the first and second skin layers. In the multilayer films, the first skin layer includes a high density polyethylene, the second skin layer includes a polyethylene, and the core layer also contains polyethylene. Further, the amount of polyethylene contained in the multilayer film is at least about 90 wt. % of the total weight of the polymers that are used to prepare the multilayer film. With regard to the amount of polyethylene in the multilayer film, the films include at least about 90 wt. % of polyethylene, at least about 92 wt. % of polyethylene, at least about 95 wt. % of polyethylene, at least about 98 wt. % of polyethylene, or at least about 99 wt. % of polyethylene, in various embodiments.

In an embodiment, the multilayer film has an overall thickness of from about 1 mil to about 9 mil.

In an embodiment, the multilayer film is a laminated film (described below). In another embodiment, the multilayer film is prepared by a coextrusion process (described below).

In some embodiments, the multilayer film comprises from 3 to 11 layers.

### Part A.1—First Skin Layer

The first skin layer corresponds to the exterior surface of the flexible package.

According to various embodiments, the first skin layer may include about 85 wt. % to 100 wt. % of a high density polyethylene having a density of about 0.950 g/cm³ to about 0.970 g/cm³, and a melt index, I₂, of about 0.5 g/10 minutes to about 10 g/10 minutes.

In an embodiment, the first skin layer has a thickness of from about 10% to 50% of the overall thickness of the multilayer film. In an embodiment, the first skin layer has a thickness of from about 20% to 40% of the overall thickness of the multilayer film.

In an embodiment, the first skin layer has a thickness of from about 0.1 mil to about 4.5 mil. In an embodiment, the first skin layer has a thickness of from about 0.2 mil to about 3.6 mil.

### Part A.2—Core Layer

The core layer corresponds to one or more layers, that are flanked on either side by the first skin layer and the second skin layer. In some embodiments, the core layer comprises from 1 to 9 layers. In some embodiments, the core layer comprises a linear polyethylene having a density of about 0.910 g/cm³ to about 0.940 g/cm³ and a melt index, I₂, of 0.5 g/10 minutes to 10 g/10 minutes.

The core layer may also comprise resins other than polyethylene, including but not limited to, ethyl vinyl alcohol (EVOH), polypropylene, and nylon. In some embodiments, the core layer comprises a layer of ethylene-vinyl-alcohol, with the proviso that the weight of the ethylene-vinyl-alcohol is from 0.5 wt. % to 8 wt. % based the total weight of the multilayer film. Contributions from other resins is preferably limited to maintain amenability to recycling.

In an embodiment, the core layer has a thickness of from about 10% to 80% of the overall thickness of the multilayer film. In an embodiment, the core layer has a thickness of from about 20% to 60% of the overall thickness of the multilayer film. In an embodiment, the core layer has a thickness of from about 30% to 50% of the overall thickness of the multilayer film

In an embodiment, the core layer has a thickness of from about 0.1 mil to about 7.2mil. In an embodiment, the core layer has a thickness of from about 0.2 mil to about 5.4 mil. In an embodiment, the core layer has a thickness of from about 0.2 mil to about 4.5 mil

### Part A.3—Second Skin Layer

The second skin layer corresponds to the side of the multilayer film that is exposed to the interior of the flexible package. The second skin layer is a sealant layer that contacts and is sealed to the fitment.

According to various embodiments, the second skin layer may include about 85wt. % to 100 wt. % of a sealant polyethylene having a molecular weight distribution Mw/Mn of about 2 to about 4, a density of about 0.880 g/cm³ to about 0.920 g/cm³, and a melt index, I₂, of about 0.3 g/10 minutes to about 5 g/10 minutes. In some embodiments, the second skin layer comprises a density of 0.905 g/cm³ to 0.917 g/cm³.

In an embodiment, the sealant polyethylene of the second skin layer is characterized by having a dilution index, Yd, of about −5.0 to about 7.0.

In an embodiment, the second skin layer has a thickness of from about 10% to 50% of the overall thickness of the multilayer film. In an embodiment, the second skin layer has a thickness of from about 20% to 40% of the overall thickness of the multilayer film.

In an embodiment, the second skin layer has a thickness of from about 0.1 mil to about 4.5 mil. In an embodiment, the second skin layer has a thickness of from about 0.2 mil to about 3.6 mil.

### Preparation of the Multilayer Film

The multilayer film may be prepared using any technology for making multilayer films known in the art. Laminated films or “structures” disclosed in U.S. patent application 2016/0229157 (“Stand Up Pouch”, inventor R. H. Clare) are suitable for use as the multilayer film in the various embodiments of this disclosure.

Suitable types of polyethylene to prepare the film include HDPE, MDPE, LLDPE, and sealant polyethylene:

In some embodiments, the laminated structure is prepared using two distinct webs that are laminated together.

In some embodiments, each web contains at least one layer of HDPE. The HDPE layers provide rigidity/stiffness to the stand up pouch (“SUP”). These HDPE layers are separated by at least one layer of lower density polyethylene (such as LLDPE) and this lower density polyethylene provides impact and puncture resistance. In addition, by separating the layers of rigid HDPE, the overall rigidity and torsional strength of the SUP is improved in comparison to a structure that contains an equivalent amount/thickness of HDPE in a single layer—in a manner that might be referred to as an “I beam” effect (by analogy to the steel I beams that are in wide use for the construction of buildings).

In another embodiment, the optical properties are improved by adding a nucleating agent to the HDPE. In another embodiment, the optical properties are improved through the use of Machine Direction Orientation (MDO) of the outer/print web. In this embodiment, a skin layer of the web that has been subjected to MDO becomes a skin layer of the laminated film structure. In yet another embodiment, the optical properties are improved by the use of MDO on a web that contains a layer of nucleated HDPE.

In one embodiment, the laminated structure is prepared with two webs, each of which contains at least one layer of HDPE. At least one HDPE layer in the first web is separated from at least one HDPE layer in the second web by a layer of lower density polyethylene, thereby optimizing the rigidity of the SUP for a given amount of HDPE.

In one embodiment, the two webs are laminated together.

In one embodiment, the laminated structure is printed at the interface between the two webs—i.e., either on the interior surface of the first web or on the exterior surface of the second web.

Detailed descriptions for various embodiments of the first (exterior) web; various embodiments of the second (interior) web; various embodiments of the adhesive, and various embodiments of the printing follow.

### First (Exterior) Web, or “A” Web

A layer of HDPE in the exterior web forms the first skin layer of the multilayer film. In one embodiment, the first (exterior) web forms the outer wall of the multilayer film.

Because one “looks through” the exterior web in order to see the printing, in some embodiments, it may be desirable for the exterior web to have low haze values. In addition, in some embodiments, a high “gloss” may be desirable, as many consumers perceive a high gloss finish as being an indication of high quality.

In another embodiment, the exterior web is subjected to Machine Direction Orientation (MDO) in an amount that is sufficient to improve the modulus (stiffness) and optical properties of the web.

Further descriptions of these two embodiments follow.

### Multi-Layer Outer Web, or Web A

In some embodiments, the use of a thick monolayer HDPE film to form the exterior web could provide a structure with adequate stiffness. However, a thick layer of HDPE may suffer from poor optical properties. This could be resolved by printing the exterior (skin) side of the outer web to form an opaque SUP. However, this design may not be very abuse resistant as the printing can be easily scuffed and damaged during transportation and handling of the SUP.

In one embodiment, these problems are mitigated by providing a coextruded multilayer film for the exterior web in which at least one skin layer is prepared from HDPE and at least one layer is prepared from a lower density polyethylene (such as LLDPE, LD, VLDPE, or plastomer).

In one embodiment, the HDPE is further characterized by having a melt index, I₂, of 0.1 to 10 (or for example from 0.3 to 3) g/10 minutes.

In one embodiment, the LLDPE is further characterized by having a melt index, I₂, of about 0.1 g/10 minutes to about 5 g/10 minutes, or about 0.3 g/10 minutes to about 3 g/10 minutes.

In one embodiment, the LLDPE is further characterized by being prepared using at least a single site catalyst (such as a metallocene catalyst) and having a molecular weight distribution, Mw/Mn (i.e., weight average molecular weight divided by number average molecular weight) of about 2 to about 4. This type of LLDPE is typically referred to as sLLDPE (where “s” refers to the single site catalyst).

In one embodiment, the very low density polyethylene (VLDPE) is an ethylene copolymer having a density of about 0.905 to 0.910 g/cm³ and a melt index, 12, of about 0.5 to 10 g/cm³.

In one embodiment, the plastomer is an ethylene copolymer having a density of about 0.880 to 0.905 g/cm³ and a melt index, I₂, of about 0.5 to 10 g/cm³.

In another embodiment, the LLDPE used in web A is sometimes blended with a minor amount (from 0.2 to 10 weight %) of an LD polyethylene having a melt index, 12, of 0.2 to 5 g/10 minutes, or for example from 0.2 to 0.8 g/10 minutes. Certain blends of these LLDPE and LLDPE and LD have been observed to have superior optical properties and superior stiffness in comparison to the LLDPE alone (particularly when the LLDPE is a sLLDPE).

In some embodiments, the use of an LD resin having a melt index of about 0.2 to 0.8 g/10 minutes has been observed to be effective for this purpose (and persons skilled in the art commonly refer to this type of LD resin as a “fractional melt LD”).

In another embodiment, the LLDPE used in web A is blended with a minor amount (from 0.2 to 10 weight %) of an HDPE resin and a nucleating agent.

The term “nucleating agent”, as used herein, is meant to convey its conventional meaning to those skilled in the art of preparing nucleated polyolefin compositions, namely an additive that changes the crystallization behavior of a polymer as the polymer melt is cooled.

Examples of conventional nucleating agents, which are commercially available and in widespread use as polypropylene additives, include dibenzylidene sorbital esters (such as the products sold under the trademark MILLAD® 3988 by Milliken Chemical and IRGACLEAR® 287 by BASF Chemicals).

In some embodiments, the nucleating agents should be well dispersed in the polyethylene. In some embodiments, the amount of nucleating agent used is comparatively small—from 200 to 10,000 parts by million per weight (based on the weight of the polyethylene)—so it will be appreciated by those skilled in the art that some care should be taken to ensure that the nucleating agent is well dispersed. In some embodiments, the nucleating agent is in a finely divided form (less than 50 microns, or for example less than 10 microns) in the polyethylene to facilitate mixing.

Examples of nucleating agents that may be suitable for use include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophtalic acid structure (or “HHPA” structure) as disclosed in U.S. Pat. No. 6,599,971 (Dotson et al., to Milliken); phosphate esters, such as those disclosed in U.S. Pat. No. 5,342,868 and those sold under the trade names NA-11 and NA-21 by Asahi Denka Kogyo and metal salts of glycerol (for example zinc glycerolate). The calcium salt of 1,2-cyclohexanedicarboxylic acid, calcium salt (CAS registry number 491589-22-1) typically provides good results for the nucleation of HDPE. The nucleating agents described above might be described as “organic” (in the sense that they contain carbon and hydrogen atoms) and to distinguish them from inorganic additives such as talc and zinc oxide. Talc and zinc oxide are commonly added to polyethylene (to provide anti-blocking and acid scavenging, respectively) and they do provide some limited nucleation functionality.

The “organic” nucleating agents described above may be better (but more expensive) nucleating agents than inorganic nucleating agents. In an embodiment, the amount of organic nucleating agent is from 200 to 2000 parts per million (based on the total weight of the polyethylene in the layer that contains the nucleating agent).

In some embodiments, these LLDPE/HDPE/nucleating agent blends have also been found to provide superior optical properties and higher modulus (higher stiffness) than 100% LLDPE.

In another embodiment, the outer web is a three layer, coextruded film of the type A/B/A where A is an HDPE and B is a lower density polyethylene, for example the LLDPE compositions described above (including the LLDPE compositions that are blends with LD and LLDPE compositions that are blends with HD and a nucleating agent). These films provide good rigidity.

### Machine Direction Orientation (MDO) of Outer Web

In another embodiment, the outer web is a multilayer, coextruded film that includes at least one skin layer of HDPE and at least one layer of a lower density polyethylene such as MDPE or LLDPE. The structure is subjected to Machine Direction Orientation (or MDO).

A description of such structures and the preparation of the structures follow.

In some embodiments, the MDO web is prepared from a multilayer film in which at least one of the layers is prepared from an HDPE composition and at least one of the layers is prepared from a polyethylene composition having a lower density than the HDPE composition.

Machine Direction Orientation (MDO) is well-known to those skilled in the art and the process is widely described in the literature. MDO takes place after a film has been formed. The “precursor” film (i.e., the film as it exists prior to the MDO process) may be formed in any conventional film molding process. Two film molding processes that are in wide commercial use (and are suitable for preparing the precursor film) are the blown film process and the cast film process.

In some embodiments, the precursor film is stretched (or, alternatively stated, strained) in the MDO process. The stretching is predominantly in one direction, namely, the “machine direction” from the initial film molding process (i.e. as opposed to the transverse direction. The thickness of the film decreases with stretching. A precursor film that has an initial thickness of 10 mils and a final thickness after stretching of 1 mil is described as having a “stretch ratio” or “draw down” ratio of 10:1 and a precursor film that has an initial thickness of 10 ml and a final thickness of 2 ml having a “stretch” or “draw down” ratio of 5:1.

In some embodiments, the precursor film may be heated during the MDO process. The temperature is typically higher than the glass transition temperature of the polyethylene and lower than the melting temperature and more specifically, is typically from about 70 to about 120° C. for a polyethylene film. Heating rollers may be used to provide this heat.

A typical MDO process utilizes a series of rollers that operate at different speeds to apply a stretching force on a film. In addition, two or more rollers may cooperate together to apply a comparison force (or “nip”) on the film.

In some embodiments, the stretched film is generally overheated (i.e. maintained at an elevated temperature—typically from about 90 to 125° C.) to allow the stretched film to relax.

### Inner Web (or “Sealant Web”)

The inner web forms the inside of a package that is prepared from the laminated structure. The inner web is a coextruded film that includes at least three layers, namely a first layer (or interface skin layer) that is prepared from at least one polyethylene selected from LLDPE and MDPE; a core layer including an HDPE composition; and a sealant layer (or interior skin layer) that is prepared from a sealant polyethylene selected from LLDPE, VLDPE and plastomer.

### Interface Skin Layer

One skin layer, the interface skin layer, of the inner web is prepared from a polyethylene composition having a lower density than HDPE so as to provide a layer having enhanced impact and tear strength properties in comparison to the layers prepared from HDPE. In one embodiment, this layer is made predominantly from an LLDPE, (including sLLDPE) having a melt index, I₂, of 0.3 to 3 g/10 minutes. The layer may also be prepared using a major amount of LLDPE (or sLLDPE) and a minor amount of LD (for example a fractional melt LD, as described above) or the LLDPE+HDPE+nucleating agent blend as described above.

In another embodiment, the interface skin layer may be prepared with MDPE (or a blend of MDPE with a minor amount of another polyethylene, such as the blends with LD; and the blends with HDPE and nucleating agent described above).

In one embodiment, the interface skin layer is printed. Accordingly, it is within the scope of this disclosure to incorporate any of the well-known film modifications that facilitate the printing process. For example, the interface skin layer may be subjected to a corona treatment to improve ink adhesion. In another embodiment, the interface skin layer may contain an opacifying agent (such as talc, titanium oxide or zinc oxide) to improve the appearance of the printed surface.

### Inner Web Core Layer

The inner web includes at least one core layer that is prepared from an HDPE composition.

HDPE is a common item of commerce. Most commercially available HDPE is prepared from a catalyst that contains at least one metal (for example chromium or a group IV transition metal: i.e. Ti, Zr, or Hf).

HDPE that is made from a Cr catalyst typically contains some long chain branching (LCB). HDPE that is made from a group IV metal generally contains less LCB than HDPE made from a Cr catalyst.

As used herein, the term HDPE refers to a polyethylene (or polyethylene blend composition, as required by context) having a density of about 0.950 g/cm³ to 0.970 g/cm³. In an embodiment, the melt index, I₂, of the HDPE is from about 0.2 g/10 minutes to 10 g/10 minutes.

In an embodiment, the HDPE is provided as a blend composition including two HDPEs, blend component a) and blend component b), where the melt index, I₂, of blend component a) is at least 10 times greater than the melt index, I₂, of blend component b). Further details of this HDPE blend composition follow.

Blend component a) of the polyethylene composition used in this embodiment includes an HDPE with a comparatively high melt index. As used herein, the term “melt index” is meant to refer to the value obtained by ASTM D1238 (when conducted at 190° C., using a 2.16 kg weight). This term is also referenced to herein as “I₂” (expressed in grams of polyethylene that flow during the 10 minute testing period, or “g/10 minutes”). As will be recognized by those skilled in the art, melt index, I₂, is in general inversely proportional to molecular weight. In one embodiment, blend component a) has a comparatively high melt index (or, alternatively stated, a comparatively low molecular weight) in comparison to blend component b).

The absolute value of I₂ for blend component a) in these blends is generally greater than 5 g/10 minutes. However, the “relative value” of I₂ for blend component a) is more important and it should generally be at least 10 times higher than the I₂ value for blend component b) (which I₂ value for blend component b) is referred to herein as I₂′). Thus, for the purpose of illustration: if the I₂′ value of blend component b) is 1 g/10 minutes, then the I₂ value of blend component a) is preferably at least 10 g/10 minutes.

In one embodiment, blend component a) may be further characterized by: i) having a density of about 0.950 g/cm³ to about 0.970 g/cm³; and ii) being present in an amount of about 5 wt. % to about 60 weight % of the total HDPE blend composition (with blend component b) forming the balance of the total composition) with amounts of about 10 wt. % to about 40 wt. %, for example about 20 wt. % to about 40 wt. %. It is permissible to use more than one high density polyethylene to form blend component a).

The molecular weight distribution (determined by dividing the weight average molecular weight (Mw) by number average molecular weight (Mn) where Mw and Mn are determined by gel permeation chromatography, according to ASTMD6474-99) of component a) may be, for example, about 2 to about 20, or, for example, about 2 to about 4, or about 4 to about 10 or about 10 to about 20. While not wishing to be bound by theory, it is believed that a low Mw/Mn value (i.e. about 2 to about 4) for component a) may improve the crystallization rate and overall barrier performance of blown films and web structures.

Blend component b) is a high density polyethylene which has a density of 0.950 g/cm³ to about 0.970 g/cm³. This includes about 0.955 g/cm³ to about 0.968 g/cm³.

The melt index, I₂, of blend component b) is also determined by ASTMD1238 at 190° C. using a 2.16 kg load. The melt index value for blend component b) (referred to herein as I₂′) is lower than that of blend component a), indicating that blend component b) has a comparatively higher molecular weight. The absolute value of I₂′ is, for example, from 0.1 to 2 g/10 minutes.

The molecular weight distribution (Mw/Mn) of component b) is not critical to the success of this disclosure, though a Mw/Mn of about 2 to about 4 is an example of a useful Mw/Mn for component b).

Finally, the ratio of the melt index of component b) divided by the melt index of component a) is for example greater than 10/1.

Blend component b) may also contain more than one HDPE resin.

The overall high density blend composition is formed by blending together blend component a) with blend component b). In an embodiment, this overall HDPE composition has a melt index (ASTM D1238, measured at 190° C. with a 2.16 kg load) of about 0.5 g/10 minutes to about 10 g/10 minutes (or for example from 0.8 g/10 minutes to 8 g/10 minutes).

The blends may be made by any blending process, such as: 1) physical blending of particulate resin; 2) co-feed of different HDPE resins to a common extruder; 3) melt mixing (in any conventional polymer mixing apparatus); 4) solution blending; or, 5) a polymerization process that employs two or more reactors.

A suitable HDPE blend composition may be prepared by melt blending the following two blend components in an extruder: from 10 to 30 weight % of component a): where component a) is an HDPE resin having a melt index, I₂, of about 15 g/10 minutes to about 30 g/10 minutes and a density of about 0.950 g/cm³ to about 0.970 g/cm³ with, from about 90 wt. % to 70 wt. % of component b): where component b) is an HDPE resin having a melt index, I₂, of about 0.8 g/10 minutes to about 2 g/10 minutes and a density of about 0.950 g/cm³ to about 0.970 g/cm³.

An example of a commercially available HDPE resin which is suitable for component a) is sold under the trademark SCLAIR® 79F, which is an HDPE resin that is prepared by the homopolymerization of ethylene with a conventional Ziegler Natta catalyst. It has a typical melt index of 18 g/10 minutes and a typical density of 0.963 g/cm³ and a typical molecular weight distribution of about 2.7.

Examples of commercially available HDPE resins which are suitable for blend component b) include (with typical melt index and density values shown in brackets): SCLAIR® 19G (melt index=1.2 g/10 minutes, density=0.962 g/cm³); MARFLEXX 9659 (available from Chevron Phillips, melt index=1 g/10 minutes, density=0.962 g/cm³); and ALATHON® L 5885 (available from Equistar, melt index=0.9 g/10 minutes, density=0.958 g/cm³).

In some embodiments, the HDPE blend composition is prepared by a solution polymerization process using two reactors that operate under different polymerization conditions. This provides a uniform, in situ blend of the HDPE blend components.

In one embodiment, the HDPE composition is prepared using only ethylene homopolymers. This type of composition is suitable if it is desired to optimize (maximize) the barrier properties of the structure.

In another embodiment, the HDPE composition may be prepared using copolymers as this will enable some improvement in the physical properties, for example, impact resistance. In yet another embodiment, a minor amount (less than 30 weight %) of a lower density polyethylene may be blended into the HDPE composition (as again, this can enable some improvement in impact resistance).

In an embodiment, the HDPE blend composition described above is combined with an organic nucleating agent (as previously described) in an amount of about 300 to 3000 parts per million by weight, based on the weight of the HDPE blend composition. The use of (previously described) calcium salt of 1,2-cyclohexane dicarboxylic acid, calcium salt (CAS 491589-22-1) is suitable. In some embodiments it is preferred to use an HDPE composition that is prepared with a group IV transition metal (for example Ti) when the HDPE composition contains a nucleating agent.

This type of “nucleated” core layer has been observed to provide outstanding barrier properties (i.e., reduced transmission of water, gas, and grease), which is desirable for many packaging applications.

In some embodiments, the presence of the nucleating agent has been observed to improve the modulus of the HDPE layer (in comparison to a non-nucleated layer of equivalent thickness).

The use of a nucleated HDPE blend composition of the type described above provides a “barrier” to oxygen and water transmission. The performance of this barrier layer is suitable for many goods. However, it will be recognized by those skilled in the art that improved “barrier” performance can be achieved through the use of certain “barrier” polymers such as ethylene-vinyl-alcohol (EVOH); ionomers and polyamides. The use of large amounts of such non-polyethylene barrier resins can make it very difficult to recycle films/structures/SUP that are made with the combination of polyethylene and non-polyethylene materials. However, it is still possible to recycle such structures if low amounts (less than 10 wt. %, or for example less than 5 weight %) of the non-polyethylene materials.

It will also be recognized by those skilled in the art that, in some embodiments, the use of certain non-polyethylene barrier resins may require the use of a “tie layer” to allow adhesion between the non-polyethylene barrier layer and the remaining layers of polyethylene.

### Sealant Layer

The inner web has two exterior layers, or “skin” layers, namely the interface skin layer described above and the interior skin layer (also referred to herein as the sealant layer). The inner web interior skin layer acts as the second skin layer of the multilayer film. The sealant layer is prepared from a “sealant” polyethylene—i.e., a type of polyethylene that readily melts and forms seals when subjected to sealing conditions.

In some embodiments, the use of lower density polyethylene copolymers is preferred. As a general rule, the cost of these lower density polyethylene's increases as the density decreases, so the “optimum” polyethylene sealant resin will typically be the highest density polyethylene that provides a satisfactory seal strength. A polyethylene having a density of about 0.900 g/cm³ to about 0.912 g/cm³ as a sealant will provide satisfactory results for many applications.

Other examples of sealant resins include ethylene-vinyl acetate (EVA) and “ionomers” (e.g., copolymers of ethylene and an acidic comonomer, with the resulting acid comonomer being neutralized by, for example, sodium, zinc, or lithium; ionomers are commercially available under the trademark SURLYN®).

The use of EVA and/or ionomers is less preferred because they can cause difficulties when the SUP is recycled (however, as previously noted, some recycling facilities will accept a SUP that contains up to 10% of EVA or ionomer and recycle the SUP as if it were constructed from 100% polyethylene).

### Printing Process

As previously noted, in some embodiments, the laminated structure may be printed at the interface between the two webs. Suitable processes include the well-known flexographic printing and roto-gravure printing techniques, which typically use nitro cellulose or water-based inks.

### Lamination/Fabrication Process

One step in the fabrication of the laminated structure requires the lamination of the first web to the second web. There are many commercially available techniques for the lamination step, including the use of a liquid glue (which may be solvent based, solventless, or water-based); a hot melt glue, and thermal bonding.

In one embodiment, the inner web has a total thickness that is about twice that of the outer web.

For example, the outer web may have a thickness of about 1 to about 1.4 mils and the inner web may have a thickness of about 2 to about 3 mils.

In a specific embodiment, the outer web includes an exterior skin layer made from HDPE (having a thickness of, for example, about 0.8 mils) and a layer of LLDPE having a thickness of, for example, about 0.4 mils. In this embodiment, the inner layer may be an A/B/C structure where layer A is made from LLDPE (having a thickness of, for example, about 0.4 mils; layer B is nucleated HDPE (having a thickness of, for example, about 1.5 mils) and layer C is sealant resin (such as VLDPE) having a thickness of, for example, about 0.3 mils.

It will be recognized by those skilled in the art that the above described thickness may be easily modified to change the physical properties of the SUP. For example, the thickness of the HDPE layers may be increased (if it is desired to produce a stiffer SUP) or the thickness of the LLDPE layer(s) may be increased to improve impact resistance.

The total thickness of the laminated structure (i.e., outer web and inner web) is about 3 to about 4 mils in one embodiment.

### Coextruded Film Structure

In an embodiment, the multilayer film that is used to prepare the flexible package is prepared by a coextrusion process. The laminated film structure described above and the coextruded film structures generally use the same (or very similar) materials of construction, with the main difference between the two types of film structures being that the “coextruded” structures do not require a lamination step—instead, all of the film layers are coextruded. The “laminated” films can provide enhanced print quality and improved scuff resistance. However, the coextruded films do not require the “lamination” step and hence may be less expensive to prepare than laminated films. In addition, the total thickness of the coextruded film structure can be essentially the same as the total thickness of the laminated structure (and the thickness of the layers in both structures can be essentially the same). As used herein “essentially the same thicknesses” are those films with a measured thickness within about 5% or less of each other, or for example within about 1% or less, or for example 0.5% or less.

### Part B—the Fitment

### General

As noted above, in some embodiments the fitment comprises an ethylene-alpha-olefin copolymer having a density of from 0.880 g/cm³ to 0.910 g/cm³. In some embodiments, the fitment comprises an ethylene-alpha-olefin copolymer having a density of from 0.890 g/cm³ to 0.910 g/cm³. The ethylene-alpha-olefin copolymer may include a VLDPE, a plastomer, or blends thereof. In some embodiments, the ethylene-alpha-olefin copolymer may comprise an LLDPE blend, where the ethylene-alpha-olefin copolymer comprises an LLDPE blended with a second LLDPE, a VLDPE, a plastomer, or combinations thereof, provided the density of the overall blend is less than 0.920 g/cm³.

In an embodiment, both the fitment and the sealant layer comprise a VLDPE, plastomer, or LLDPE blend having a dilution index, Yd, of about −5.0 to about 7.0.

In an embodiment, the fitment comprises a VLDPE, plastomer, or LLDPE blend having a dilution index, Yd, of about −5.0 to about 7.0.

### Shape

This disclosure is not intended to be limited to the use of any particular size or shape of fitment. In some embodiments, flexible packages having integral fitments tend to have size ranges from a few tens of millimeters at the small end to about 30 milliliters at the large end. The fitment size generally is proportional to the size of the package—i.e. smaller fitments are used with smaller packages and larger fitments are used with larger packages. The size of the fitment opening (which allows the contents of the package to be removed from it) will also generally be proportional to the package size—although it is also well known to use larger openings for packages that contain solids and/or viscous liquids or slurries (in comparison to smaller diameter fitments that may be used with nonviscous liquids such as soft drinks).

The fitment may contain a valve to control flow of a liquid from the pouch. More commonly, the fitment will have a threaded connection that cooperates with a threaded cap or closure.

The fitment may be designed to improve the sealability of the fitment to the film and/or the strength of the fitment. Common examples of such fitments include “shoulders” around the fitment opening—and “ribs” along the depth of the fitment. One type of fitment is referred to as a “canoe” because a top view of the fitment resembles the shape of a canoe—the use of this type of fitment is illustrated in the examples.

A “ribbed canoe” fitment has two or more ribs that run the outside length of the canoe—with the ribs being at different depths from the top of the canoe.

### Materials

As noted above, the recyclable, flexible packing includes a fitment. The fitment may be a soft touch fitment. As used herein, “soft touch” means when the fitment is made of at least 80% plastomer and the fitment has Shore D surface hardness value less than 35 (as measured by ASTM D2240-15 (2021)), Shore A surface hardness value less than 90 (as measured by ASTM D2240-15 (2021)), and/or 1% flexural secant modulus less than 25,000 psi (as measured by ASTM D790-17), and flexural yield strength less than 1500 psi (as measured by ASTM D790-17).

In one aspect, the fitment is prepared from an ethylene-alpha-olefin copolymer having a density of about 0.880 g/cm³ to about 0.920 g/cm³. This includes ethylene-alpha-olefin copolymers having a density of about 0.880 g/cm³ to about 0.910 g/cm³, or from about 0.89 g/cm³ to about 0.91 g/cm³. The ethylene-alpha-olefin copolymers may be polymers made using transition metal catalysts, such as metallocene catalysts. Accordingly, in some embodiments, the ethylene-alpha-olefin copolymer may include the reaction products of the transition metal (i.e. metallocene) catalysts. As such, in some embodiments, the ethylene-alpha-olefin copolymer may include 0.0015 parts per million of the reaction product of a metallocene catalyst. As such, in some embodiments, the ethylene-alpha-olefin copolymer may include metals such as hafnium or titanium. In other embodiments, the ethylene-alpha-olefin copolymer include at least about 0.0015 parts per million (ppm) of the transition metal (e.g. hafnium or titanium). In other embodiments, the ethylene-alpha-olefin copolymer used for the fitment exhibits a 1% flexural secant modulus less than 30,000 psi.

In another aspect, the fitment includes a blend of two or more of a VLDPE, plastomer, and LLDPE resins, the blend having a density of less than about 0.920 g/cm³ and melt index (measuring using a load of 2.16 kg at 190° C.) of about 5 g/10 minutes or greater. In some embodiments, the blend exhibits a density of about 0.880 g/cm³ to about 0.920 g/cm³ and melt index, I₂, of about 20 g/10 minutes to 50 g/10 minutes. In some embodiments, the blend exhibits a melt index of about 7 g/10 minutes or greater, about 10 g/10 minutes or greater; about 15 g/10 minutes or greater; or about 20 g/10 minutes or greater. As with the fitments above, the ethylene-alpha-olefin copolymers (i.e. the LLDPE, VLDPE, and plastomer) may be polymers made using transition metal catalysts, such as metallocene catalysts. Accordingly, in some embodiments, the ethylene-alpha-olefin copolymer may include the reaction products of the transition metal (i.e. metallocene) catalysts. As such, in some embodiments, the ethylene-alpha-olefin copolymer may include metals such as hafnium or titanium. In other embodiments, the ethylene-alpha-olefin copolymer include at least about 0.0015 parts per million (ppm) of the transition metal (e.g. hafnium or titanium).

### Welding the Film to the Fitment

The present disclosure is not intended to be limited to the use of any particular welding (heat sealing) technique. Common/conventional techniques are generally suitable. Also, ultrasonic and laser sealing technique can be used. According to embodiments disclosed herein, the welding of the multilayer film to the fitment may be done under pressure and elevated temperature, for a specified period of time. In some embodiments, the pressure applied to the fitment and film is about 15 psi to about 50 psi. This may include pressures of about 15 psi to about 40 psi, about 20 psi to about 50 psi, or about 20 psi to about 40 psi. The elevated temperature may be from about 130° C. to about 180° C. This may include temperatures of about 140° C. to about 170° C., about 130° C. to about 160° C., about 140° C. to about 160° C., or about 150° C. to about 175° C. The time period, or dwell time, that the pressure is applied at temperature may be less than about 5 seconds. This may include less than about 4 second, or less than about 3 seconds, or the time period may be about 0.5 seconds to about 4.5 seconds, about 0.5 seconds to about 4 seconds, about 0.5 seconds to about 3 seconds, or about 0.5 seconds to about 2.5 seconds. The pressure bar may be applied one or more times to achieve the desired seal.

### Fitment Making

The fitments of this disclosure are made from a very low density polyethylene (VLDPE), a plastomer, or a blend of a VLDPE and/or plastomer with a linear low density polyethylene (LLDPE), having a density of about 0.880 g/cm³ to about 0.930 g/cm³; or they are made as indicated above from a blend of two or more of VLDPE, plastomer, and LLDPE having an I₂ value of about 5 g/10 minutes or greater, and a density of less than 0.92 g/cm³. In some embodiments, the blend has a melt index of about 7 g/10 minutes or greater, about 10 g/10 minutes or greater; about 15 g/10 minutes or greater; or about 20 g/10 minutes or greater. VLDPE, plastomers, and LLDPE are all individually copolymers of ethylene and an α-olefin comonomer such as, but not limited to, 1-butene, 1-hexene, 1-octene, or mixtures of any two or more thereof.

In an embodiment, the VLDPE, plastomer, or LLDPE, has a melt index, “I₂,” (as determined by ASTM D1923 at 190° C. with a 2.16 kg load) of about 0.2 g/10 minutes to about 50 g/10 minutes. This may include about 1 g/10 minutes to about 40 g/10 minutes, about 3 g/10 minutes to about 40 g/10 minutes, about 10 g/10 minutes to about 30 g/10 minutes, or about 20 g/10 minutes to about 40 g/10 minutes. In other embodiments, the blend of any two or more of VLDPE, plastomer, and LLDPE has an I2 value of about 20 g/10 minutes to about 55 g/10 minutes, and a density of about 0.880 g/cm³ to about 0.920 g/cm³. This includes where the blend of any two or more of VLDPE, plastomer, and LLDPE has an I₂ value of about 20 g/10 minutes to about 40 g/10 minutes, and a density of about 0.890 g/cm³ to about 0.920 g/cm³, or any combination of such parameters.

In some embodiments, the VLDPE, plastomer, or LLDPE may be prepared in any type of polymerization process (such as a gas phase; slurry; or solution process) using any suitable type of catalyst, including “homogenous” catalysts (also referred to as “single site” catalysts) or heterogenous catalysts.

Metallocene catalysts are well known “homogeneous” catalysts. Ziegler Natta catalysts are well known heterogeneous catalysts. The resulting VLDPE, plastomer, or LLDPE may have a “homogeneous” comonomer incorporation (as indicated by having a Short Chain Branching Distribution Index, or SCBDI, of greater than 70%) or a “heterogeneous” comonomer distribution. It is also known to prepare VLDPE, plastomer, or LLDPE in a multi-reactor process in which a homogeneous catalyst is used in one reactor and a homogeneous or heterogeneous catalyst is used in another—and such VLDPE, plastomer, or LLDPE is suitable for use in this disclosure.

Dilution Index, Yd, is based on rheological measurements, and may be calculated as described in U.S. Pat. No. 9,512,282, assignee NOVA Chemicals (International) S.A. In addition to having molecular weights, molecular weight distributions and branching structures, blends of ethylene polymers may exhibit a hierarchical structure in the melt phase. In other words, the ethylene polymer components may be, or may not be, homogeneous down to the molecular level depending on polymer miscibility and the physical history of the blend. Such hierarchical physical structure in the melt is expected to have a strong impact on flow and on processing and converting, as well as the end-use properties of manufactured articles. The nature of this hierarchical physical structure between ethylene polymers can be characterized by Yd (“Dilution Index”). Yd values about −5.0 to about 7.0, are used in various embodiments.

The branching distribution in ethylene copolymers may be defined using the short chain branching distribution index (SCBDI). Polyethylene copolymers that are prepared with a metallocene catalyst generally have a narrow branching distribution (which corresponds to a high SCBDI value). SCBDI is defined as the weight % of the polymer that has a comonomer content with 50% of the median comonomer content of the polymer. SCBDI is determined according to the method described in U.S. Pat. No. 5,089,321 (Chum et al.). SCBDI of about 70 to about 100, may be used to define/describe a “narrow branching distribution” in an ethylene copolymer.

The present invention, thus generally described, will be understood more readily by reference to the following examples, which are provided by way of illustration and are not intended to be limiting of the present invention.

### EXAMPLES

### General

The following examples illustrate sealing efficiency between a multilayer polyethylene film and a proxy fitment made from one of a VLDPE, plastomer, or a blend of a VLDPE or plastomer with an LLDPE. For all examples, a multilayer polyethylene film structure (the “test film”) was heat sealed to a proxy substrate (representing a fitment) comprising VLDPE, plastomer, or a blend of a VLDPE or plastomer and an LLDPE. Test films, comprising a skin layer made from HDPE, a second skin layer made from a sealant grade of polyethylene, and a core layer including polyethylene, and having greater than 90 wt. % polyethylene were prepared as described below.

Resins used for preparation of the multilayer film and the various proxy fitments, and their corresponding description, density, melt index, and product name (if known), are summarized in Table 1 below. Resins were sourced from NOVA Chemicals unless otherwise indicated. The resins were given a resin identifier (ID) for ease of identification in the description of the examples.

TABLE 1
Resins Summary

| Identifier | Description | Density | MI | Other |
|---|---|---|---|---|
| PE-1 | HDPE | 0.958 | 1.0 | SCLAIR ® 19C |
| | (homopolymer) | | | |
| PE-2 | HDPE | 0.954 | 0.8 | NOVAPOL ® 534 |
| | (hexene copolymer) | | | |
| PE-3* | HDPE | 0.967 | 1.2 | SURPASS ® HPs167 |
| | (homopolymer) | | | |
| HDPE-1 | HDPE | 0.950 | 51.00 | SCLAIR 2714 |
| | (homopolymer) | | | |
| HDPE-2 | HDPE | 0.950 | 17.20 | SCLAIR 2710 |
| | (butene copolymer) | | | |
| LLDPE-1 | LLDPE | 0.920 | 52.0 | SCLAIR 2114 |
| | (butene copolymer) | | | |
| LLDPE-2 | LLDPE | 0.912 | 4.0 | SURPASS VPs412 |
| | (octene copolymer) | | | |
| LLDPE-3 | LLDPE | 0.920 | 1.0 | SCLAIR FP120 |
| | (octene copolymer) | | | |
| LLDPE-4 | LLDPE | 0.914 | 0.9 | SURPASS VPsK914 |
| | (octene copolymer) | | | |
| VLDPE-1 | VLDPE | 0.909 | 4.88 | Experimental |
| | (octene copolymer) | | | |
| VLDPE-2 | VLDPE | 0.906 | 3.5 | Experimental |
| | (octene copolymer) | | | |
| PLAST-1 | Plastomer | 0.894 | 28.00 | Experimental |
| | (octene copolymer) | | | |
| PLAST-2 | Plastomer | 0.886 | 5.54 | Experimental |
| | (octene copolymer) | | | |
| PLAST-3 | Plastomer | 0.896 | 5.73 | Experimental |
| | (octene copolymer) | | | |
| PLAST-4 | Plastomer | 0.905 | 3.5 | Experimental |
| | (octene copolymer) | | | |

*Indicates nucleated

Representative examples of a multilayer film (“test films”) in accordance with the present disclosure were prepared as described below.

Test film-1 was prepared by lamination in accordance with known/published techniques. Specifically, test film-1 was formed from lamination of an outer web to a sealant web. The compositions of the webs are described below:
Outer web: 3 layers with at total thickness of 1.15 mil
   0.40 mil of PE-1
   0.35 mil of PE-1
   0.40 mil of PE-2
Sealant web: 3 layers with at total thickness of 2.35 mil
   0.40 mil of PE-2
   1.50 mil of PE-3
   0.45 mil of LLDPE-4

The outer and sealant webs were made by coextrusion. Test film-1 was made by laminating the above two webs together using a conventional adhesive. The PE-1 layer in the outer web represents the first skin layer and the LLDPE-4 layer of the sealant web represents the second skin layer.

Test film-2 was prepared by co-extrusion of 9 layers at an overall thickness of 3.5 mil. The layers of test film-2 were as follows:
Layer 1:0.175 mil of PE-1
Layer 2:0.56 mil of PE-3
Layer 3:0.28 mil of PE-2
Layer 4:0.28 mil of PE-2
Layer 5:0.245 mil of PE-2
Layer 6:0.665 mil of PE-3
Layer 7:0.665 mil of PE-3
Layer 8:0.315 mil of LLDPE-3
Layer 9:0.315 mil of LLDPE-4

For test film-2, layer 1 represents the first skin layer and layer 9 represents the second skin layer.

Test film-3 was prepared in identical fashion as test film-2 in regard to layers 1 through 7. Layers 8 and 9 for test film-3 were as follows:
Layer 8:0.315 mil of LLDPE-4
Layer 9:0.315 mil of LLDPE-3.

For test film-3, layer 1 represents the first skin layer and layer 9 represents the second skin layer.

In the following examples, a rectangular shaped proxy fitment was prepared as a substitute for the fitment in demonstrating the sealing efficiency between various polyethylene compositions and the test films. Dimensions for the proxy fitment differ between experiments as described below for each experiment. The proxy fitments were punched out of compression molded plaques, use of which is convenient because it simplifies the sealing machinery and because it facilitates the testing of the strength of the seal. The sealed samples were then tested for seal strength using a Universal Testing Machine. The proxy fitments were also subjected to hardness testing to demonstrate the soft touch characteristic of plastomer based fitments.

For each experiment, 5 mm seals were formed between the proxy fitments and test films using a LAKO® SL-5 Crimp sealer using different dwell times, seal bar temperatures, and pressures, as described below for each experiment. The seals were aged for at least 24 hours before measuring seal strength using an INSTRON* Tensile Tester using conditions described below. In some instances, a failure of sealing was observed, particularly with respect to proxy fitments made from HDPE (HDPE-1 and HDPE-2). Two different failures were observed. The first was a failure to form a seal with the film, believed to be a result of either i) a sealing temperature that is too low, ii) a sealing time that is too short; iii) a sealing pressure that is too low, or some combination of i)-iii). The second was a failure of the film that is referred to by those skilled in the art as “burn through”. This type of failure is believed to be a result of either a) a sealing temperature that is too high; b) a sealing time that is too long; c) a sealing pressure that is too high, or some combination of a)-c).

### Experiment Set #1

In a first set of experiments, proxy fitments made from VLDPE, plastomer, LLDPE (comparative), or HDPE (comparative) resins found in Table 1 and measuring 0.25″ thick, 1.0″ wide, and 8″ long were sealed to test film-1, with resulting seals assessed for seal strength and assigned a “seal score”. Sealing conditions included five seal bar temperatures (150, 160, 165, 170, and 175° C.), two pressures (20 and 40 psi), and four dwell times (1.0, 1.5, 2.0, and 2.5 s). Seal strength was assessed using a conventional Instron™ Tensile Tester with 12″/min pull (crosshead) speed and 90° pull direction.

The seal failure modes were reported to calculate the ‘seal score’ in different sealing conditions for each resin. The sealing score for each proxy fitment show below is an aggregate of 5 separate tests for each set of sealing conditions.

TABLE 2
Failure Modes and Values.

| Failure Mode | Failure Mode Value |
|---|---|
| Even Peel | 0.1 |
| (Undesirable failure mode in industry) | |
| Peel and stretch | 1 |
| Tensile failure | 2 |
| (Most desirable failure mode in industry) | |

Based on the values defined in Table 2, seal score data were calculated using the following equation;

$$Seal score = ( P \times 0.1 + S \times 1 + T \times 2 ) when P + S + T = 5$$

Where P is the number of samples failed in “even peel” mode, S is the number of samples failed in “peel and stretch mode” and T is the number of samples failed in “tensile failure mode”. Higher seal scores are desirable.

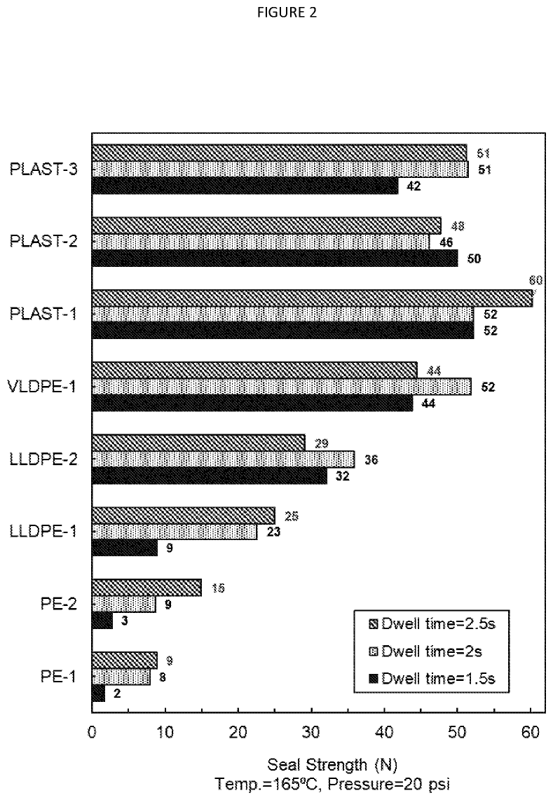

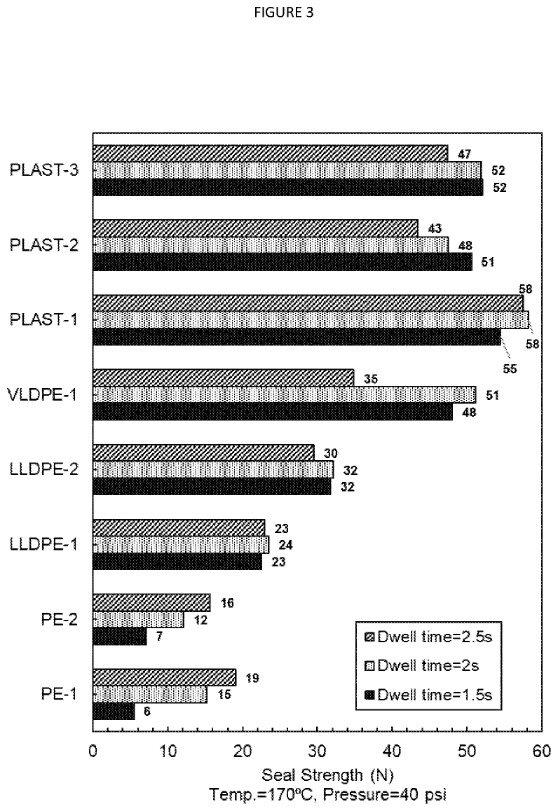

Seal strength (SS) and seal score (SC) data obtained using proxy fitments made from VLDPE or plastomer and sealed to test film-1 is shown in Table 3. The sealing conditions shown include seal bar temperature (° C.), pressure (psi), and dwell time(s). Proxy fitments made from LLDPE-1 or LLDPE-2 are included for comparison. Furthermore, FIG. 2 through FIG. 4 are graphic illustrations of the difference in seal strength for the same proxy fitments along with additional comparative examples, PE-1, PE-2, and LLDPE-1.

TABLE 3
Seal Strength and Seal Score Summary

| | VLDPE-1 | | PLAST-1 | | PLAST-2 | | PLAST-3 | | LLDPE-1 | | LLDPE-2 | |
|---|---|---|---|---|---|---|---|---|---|---|---|---|
| Conditions | SS | | SS | | SS | | SS | | SS | | SS | |
| (° C./psi/s) | (N) | SC | (N) | SC | (N) | SC | (N) | SC | (N) | SC | (N) | SC |
| 150/20/1.0 | 16.4 | 6 | 39.1 | 5 | 46.4 | 5 | 30.9 | 5 | | | | |
| 150/20/1.5 | 45.4 | 6 | 52.0 | 6 | 46.8 | 5 | 44.5 | 5 | | | | |
| 150/40/1.0 | 18.0 | 5 | 41.4 | 5 | 46.0 | 5 | 33.7 | 5 | | | | |
| 150/40/1.5 | 32.2 | 5 | 49.7 | 5 | 51.2 | 7 | 45.3 | 5 | | | | |
| 160/40/1.5 | 39.3 | 5 | 54.1 | 7 | 51.4 | 8 | 51.0 | 10 | 7.3 | 0.5 | 28.1 | 7.0 |
| 160/40/2.5 | 54.1 | 6 | 57.4 | 7 | 55.1 | 10 | 50.1 | 10 | 24.7 | 5.0 | 32.2 | 9.0 |
| 165/20/1.5 | 43.8 | 10 | 52.2 | 8 | 50.0 | 10 | 41.8 | 10 | 8.9 | 0.5 | 32.0 | 5.0 |
| 165/20/2.5 | 44.4 | 10 | 60.2 | 9 | 47.7 | 10 | 51.2 | 10 | 25.0 | 6.0 | 29.1 | 10.0 |
| 165/40/2.0 | 51.9 | 8 | 52.2 | 9 | 46.2 | 10 | 51.5 | 10 | 22.5 | 5.0 | 35.9 | 7.0 |
| 170/40/1.5 | 48.0 | 6 | 54.5 | 5 | 50.6 | 8 | 52.1 | 9 | 22.5 | 8.0 | 31.7 | 7.0 |
| 170/40/2.5 | 34.8 | 10 | 57.5 | 10 | 43.4 | 10 | 47.4 | 10 | 23.0 | 10.0 | 29.6 | 7.0 |
| 170/20/2.0 | 51.1 | 10 | 58.3 | 9 | 47.5 | 10 | 51.9 | 10 | 23.5 | 5.0 | 32.1 | 8.0 |
| 175/20/2.5 | 37.4 | 10 | 61.6 | 10 | 47.7 | 10 | 48.1 | 10 | 21.1 | 10.0 | 29.5 | 7.0 |
| 175/20/1.5 | 53.1 | 6 | 55.2 | 5 | 44.6 | 10 | 48.0 | 10 | 22.4 | 5.0 | 31.0 | 9.0 |
| 175/40/2.0 | 34.3 | 10 | 53.7 | 10 | 45.3 | 10 | 47.1 | 10 | 23.3 | 10.0 | 30.2 | 10.0 |

The data demonstrates that proxy fitments comprising VLDPE or plastomer form stronger seals with test film-1 when compared to proxy fitments made from LLDPE or HDPE. The seal strength values of inventive plastomer/VLDPE proxy fitments are significantly higher than those of the Comparative Examples (LLDPE or HDPE). More interestingly, sufficiently good seals were not formed for the Comparative Examples at seal bar temperatures below 160° C. ( ). However, seals with very good seal strength and good seal score values could be formed using VLDPE or plastomer at a seal bar temperature of 150° C. even at a short dwell time of 1 second, as shown in Table 3.

The proxy fitments for the first set of experiments were also assessed for hardness and flexural modulus. Shore D and Shore A tests were performed on the proxy fitments in accordance with ASTM D2240. The method is based on the penetration of a specified inventor, forced into the material under specified conditions. The indentation hardness is inversely related to the penetration and is dependent on the elastic modulus and viscoelastic behavior of the material. The shape of the indentor and the force applied to it influence the results obtained so that there may be no simple relationship between the results obtained with one type of durometer and those obtained with either another type of durometer or another instrument for measuring hardness. The main difference between the Shore D (Type D) and Shore A (Type A) hardness measurements is the use of different type/shape of indentors. The dimensions and figures of indentors used for Shore D and Shore A hardness measurements are provided by ASTM D2240-15 (2021). The procedure is as follows:

Perform verification on test blocks prior to testing.
1. Samples need to be pressed into plaques for measuring the surface hardness values. Requires a specimen thickness of at least 240 mil as per ASTM D2240-15 (2021).
2. Place the specimen under the indentor so that the point of the indentor is at least 12 mm (0.5 in) from any edge of the specimen.
3. Apply the pressor foot to the specimen keeping the foot perpendicular to the surface of the specimen. Apply just enough pressure to obtain firm contact between pressor foot and specimen.
4. Read the scale within 1 second and after 15 seconds after the pressor foot is in firm contact with the specimen.
5. Make the measurements of hardness at different positions on the specimens, at least 6 mm (0.25 in) apart and determine the average. Requires 5 measurements to be performed as per ASTM D2240-15 (2021).

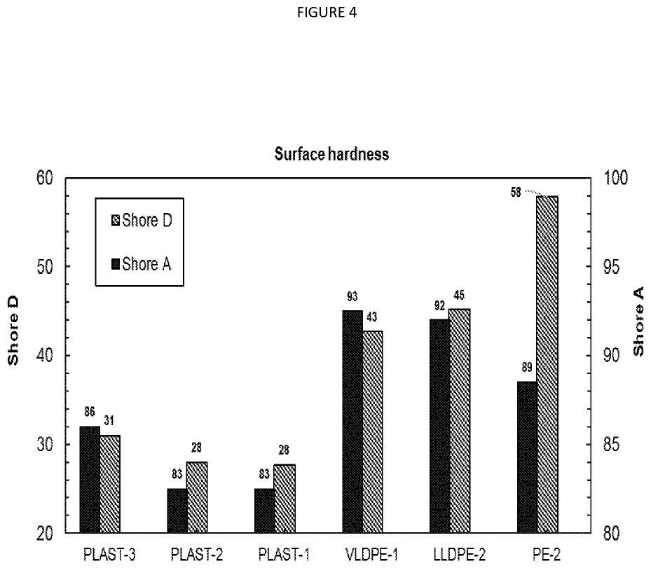

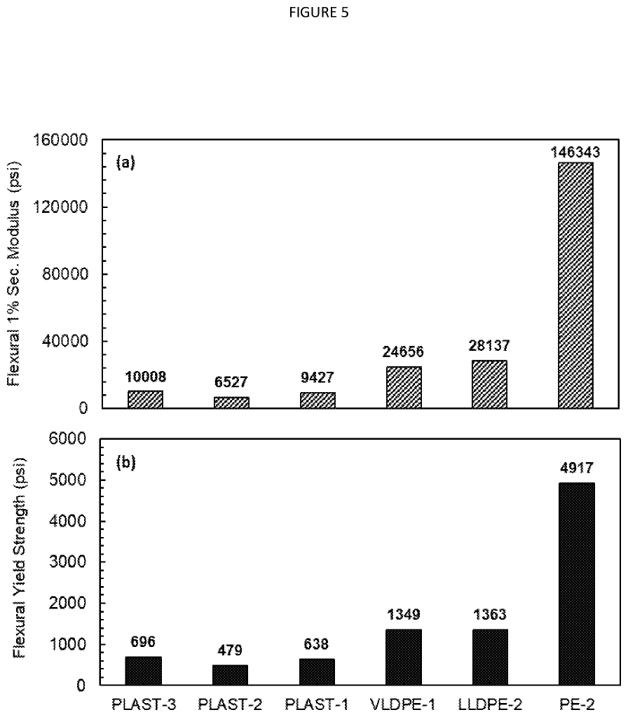

Proxy fitments made using VLDPE or plastomer described herein display low surface hardness (shore D hardness values less than 40) (see FIG. 4), which is similar to thermoplastic rubbers such as styrene-butadiene-styrene (SBS), and diblock and triblock thermoplastic elastomers, polyester thermo plastic elastomers, and thermoplastic polyurethane (TPU) compositions suitable for soft-touch applications. Also, the inventive examples using VLDPE or plastomer display low flexural modulus values (≤170 MPa, i.e. about 25,000 psi, see FIG. 5) desired for making soft touch components.

### Experiment Set #2

In a second set of experiments, proxy fitments made with blends of two different LLDPEs or a blend of LLDPE and a VLDPE and measuring 0.25″ thick, 0.5″ wide, and 8″ long were sealed to test film-2 and test film-3, with resulting seals assessed for seal strength. The prepared blends, including contribution of the LLDPE and VLDPE resins in the prepared blend (in wt. %), and associated properties are displayed in Table 4 below. As seen in the Table 4 the blends exhibited a density of less than about 0.920 g/cm³ and a melt index of about 7 g/10 minutes, or greater.

TABLE 4
LLDPE Blends

| | Weight Fraction (wt. %) | | | Blend | Blend |
|---|---|---|---|---|---|
| Sample | LLDPE-1 | LLDPE-2 | VLDPE-2 | MI^{a} | Density |
| LLDPE-1 | 100 | | | 52.0^{b} | 0.925^{a} |
| HDPE-2 | | | | 17.2^{b} | 0.951^{a} |
| Sample 5B | 55 | 45 | | 16.0 | 0.919 |
| Sample 5D | 45 | 55 | | 12.3 | 0.917 |
| Sample 5F | 35 | 65 | | 9.5 | 0.916 |
| Sample 6G | 45 | | 55 | 12.0 | 0.914 |

^{a}MI is based upon a weighted calculation, except where otherwise noted.
^{b}not the blend value for the control, rather the value of that particular material.
^{c}measured MI.

Seal strength values for proxy fitments made from the LLDPE blends and sealed to test film-2 are in Table 5, and seal strength values for proxy fitments made from the LLDPE blends and sealed to test film-3 are shown in Table 6. Seal strengths greater than 27.5 N are generally accepted as suitable for use in commercial flexible packages. Seal strengths in both Table 5 and 6 that are greater than 27.5 N are indicated by light grey shading.

TABLE 5
Seal Scores Between LLDPE Blends and Test Film-2

| | Fitment | Seal Time | Seal Bar Temperature (° C.) | | | | |
|---|---|---|---|---|---|---|---|
| Blend | Density | (s) | 120 | 130 | 140 | 150 | 160 |
| HDPE-2 | 0.951 | 1 | 0.00 | 0.00 | 0.00 | 0.00 | 0.30 |
| HDPE-2 | 0.951 | 2 | 0.00 | 0.00 | 0.00 | 0.67 | 1.51 |
| HDPE-2 | 0.951 | 3 | 0.00 | 0.00 | 0.00 | 0.79 | 11.96 |
| HDPE-2 | 0.951 | 4 | 0.00 | 0.00 | 0.00 | 3.86 | 11.88 |
| LLDPE-1 | 0.925 | 1 | 0.00 | 0.00 | 0.00 | 0.00 | 1.91 |
| LLDPE-1 | 0.925 | 2 | 0.00 | 0.00 | 0.00 | 4.86 | 10.55 |
| LLDPE-1 | 0.925 | 3 | 0.00 | 0.00 | 2.24 | 11.52 | 22.22 |
| LLDPE-1 | 0.925 | 4 | 0.00 | 0.78 | 3.64 | 18.39 | 22.79 |
| Sample 5B | 0.919 | 1 | 0.00 | 0.00 | 1.00 | 5.60 | 16.80 |
| Sample 5B | 0.919 | 2 | 0.00 | 1.00 | 9.70 | 24.00 | 30.50 |
| Sample 5B | 0.919 | 3 | 0.40 | 4.60 | 21.60 | 27.80 | 33.40 |
| Sample 5B | 0.919 | 4 | 0.90 | 10.60 | 25.60 | 33.10 | 29.80 |
| Sample 5D | 0.917 | 1 | 0.00 | 0.30 | 0.60 | 6.00 | 18.30 |
| Sample 5D | 0.917 | 2 | 0.00 | 2.90 | 12.70 | 27.10 | 32.30 |
| Sample 5D | 0.917 | 3 | 0.48 | 6.50 | 24.70 | 32.50 | 37.20 |
| Sample 5D | 0.917 | 4 | 1.40 | 13.00 | 27.90 | 37.20 | 32.60 |
| Sample 5F | 0.916 | 1 | 0.00 | 0.00 | 0.90 | 10.00 | 21.30 |
| Sample 5F | 0.916 | 2 | 0.40 | 1.10 | 17.80 | 27.30 | 29.40 |
| Sample 5F | 0.916 | 3 | 1.20 | 12.10 | 25.90 | 32.70 | 35.70 |
| Sample 5F | 0.916 | 4 | 3.00 | 18.80 | 28.20 | 32.00 | 30.20 |
| Sample 6G | 0.914 | 1 | 0.00 | 0.00 | 0.00 | 11.97 | 24.47 |
| Sample 6G | 0.914 | 2 | 0.00 | 2.76 | 3.57 | 15.21 | 32.74 |
| Sample 6G | 0.914 | 3 | 0.00 | 10.10 | 21.91 | 27.74 | 35.11 |
| Sample 6G | 0.914 | 4 | 2.45 | 20.93 | 27.53 | 27.55 | 36.00 |

TABLE 6
Seal Scores Between LLDPE Blends and Test Film-3

| | Fitment | Seal Time | Seal Bar Temperature (° C.) | | | | |
|---|---|---|---|---|---|---|---|
| Blend | Density | (s) | 120 | 130 | 140 | 150 | 160 |
| HDPE-2 | 0.951 | 1 | 0.00 | 0.00 | 0.00 | 0.00 | 1.37 |
| HDPE-2 | 0.951 | 2 | 0.00 | 0.00 | 0.91 | 3.14 | 6.27 |
| HDPE-2 | 0.951 | 3 | 0.00 | 0.00 | 1.13 | 7.05 | 15.33 |
| HDPE-2 | 0.951 | 4 | 0.00 | 0.93 | 3.14 | 13.37 | 19.63 |
| LLDPE-1 | 0.925 | 1 | 0.00 | 0.00 | 2.78 | 4.94 | 5.85 |
| LLDPE-1 | 0.925 | 2 | 0.00 | 3.13 | 13.08 | 20.49 | 22.22 |
| LLDPE-1 | 0.925 | 3 | 0.00 | 6.99 | 15.52 | 22.97 | 23.06 |
| LLDPE-1 | 0.925 | 4 | 4.56 | 11.19 | 20.95 | 23.24 | 23.74 |
| Sample 5B | 0.919 | 1 | 0.00 | 1.20 | 7.10 | 22.50 | 23.60 |
| Sample 5B | 0.919 | 2 | 0.00 | 21.40 | 23.70 | 27.50 | 32.00 |
| Sample 5B | 0.919 | 3 | 12.70 | 24.90 | 26.40 | 28.50 | 26.40 |
| Sample 5B | 0.919 | 4 | 16.80 | 24.90 | 28.10 | 33.50 | 24.90 |
| Sample 5D | 0.917 | 1 | 0.00 | 2.80 | 16.20 | 23.10 | 21.40 |
| Sample 5D | 0.917 | 2 | 6.10 | 19.60 | 22.20 | 27.40 | 31.60 |
| Sample 5D | 0.917 | 3 | 13.40 | 24.50 | 25.90 | 31.00 | 25.70 |
| Sample 5D | 0.917 | 4 | 18.20 | 25.70 | 30.70 | 34.10 | 25.50 |
| Sample 5F | 0.916 | 1 | 0.00 | 0.70 | 8.40 | 23.10 | 26.00 |
| Sample 5F | 0.916 | 2 | 4.20 | 12.20 | 28.60 | 30.30 | 28.50 |
| Sample 5F | 0.916 | 3 | 11.00 | 24.00 | 30.00 | 32.10 | 24.00 |
| Sample 5F | 0.916 | 4 | 19.00 | 26.60 | 31.20 | 28.70 | 25.80 |
| Sample 6G | 0.914 | 1 | 1.01 | 2.03 | 18.70 | 25.19 | 27.03 |
| Sample 6G | 0.914 | 2 | 8.94 | 21.72 | 25.32 | 28.59 | 34.05 |
| Sample 6G | 0.914 | 3 | 19.23 | 25.45 | 28.15 | 32.28 | NT |
| Sample 6G | 0.914 | 4 | 22.28 | 26.27 | 29.59 | 35.04 | NT |

NT—not tested

The data in Tables 5 and 6 indicate that proxy fitments prepared with LLDPE blends having densities below 0.920 g/cm³ form stronger seals with both test films as compared to proxy fitments prepared with the control resins HDPE-2 and LLDPE-1. In fact, the proxy fitments prepared with control resins failed to produce any seal strengths higher than 27.5 N at any of the seal temperatures and seal times used. Also, as the density of the blend used for the proxy fitment decreased due to increasing the fraction of a lower density LLDPE or due to inclusion of a VLDPE the higher the seal strength. The strongest seals were seen with the proxy fitments having the lowest densities (0.916 g/cm³ and 0.914 g/cm³ for Samples 5F and 6G, respectively), particularly when sealed to test film-3 with a sealant layer having a density of 0.905 g/cm³. The effect was seen at seal temperatures between 140° C. and 160° C. with seal times as low as 2 seconds. While the examples do not include blending of a plastomer, as defined herein, with an LLDPE, it should be noted that VLDPE-2 possesses a density of 0.906 g/cm³, which borders the upper limit for density of plastomers. Therefore, a person skilled in the art would appreciate that a blend of an LLDPE and a plastomer having a density less than 0.920 g/cm³ would be expected to demonstrate similar seal strengths to those described herein with proxy fitments prepared with LLDPE and VLDPE blends.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

### INDUSTRIAL APPLICABILITY

The present disclosure relates to a flexible package formed mainly from polyethylene and comprising a multilayer film and a fitment.

1. A flexible package comprising:
a multilayer film comprising:
a first skin layer comprising a high density polyethylene having a density of about 0.950 g/cm³ to about 0.970 g/cm³ and a melt index, I₂, of about 0.5 g/10 minutes to 10 g/10 minutes;
a core layer comprising polyethylene; and
a second skin layer comprising a sealant polyethylene having a molecular weight distribution Mw/Mn of 2 to 4, a density of 0.880 g/cm³ to 0.920 g/cm³, and a melt index, I₂, of 0.3 g/10 minutes to 5 g/10 minutes;
wherein the multilayer film is at least 90 wt. % polyethylene; and
a fitment sealed to the second skin layer, the fitment comprising an ethylene-alpha-olefin co-polymer having a density of 0.880 g/cm³ to 0.910 g/cm³.

2. The flexible package of claim 1, wherein the first skin layer comprises 85 wt. % to 100 wt. % of the high density polyethylene.

3. The flexible package of claim 1, wherein the second skin layer comprises 85 wt. % to 100 wt. % of the sealant polyethylene.

4-5. (canceled)

6. The flexible package of claim 1, wherein the fitment comprises at least 0.0015 parts per million of hafnium or titanium.

7. (canceled)

8. The flexible package of claim 4, wherein the fitment exhibits a flexural secant modulus of less than 30,000 psi.

9. The flexible package of claim 1, wherein the core layer comprises a linear polyethylene having a density of about 0.910 g/cm³ to about 0.940 g/cm³ and a melt index, I₂, of 0.5 g/10 minutes to 10 g/10 minutes.

10. (canceled)

11. The flexible package of claim 1, wherein the second skin layer exhibits a density of 0.905 g/cm³ to 0.917 g/cm³.

12. (canceled)

13. The flexible package of claim 1, wherein the sealant polyethylene has a molecular weight distribution, Mw/Mn, of about 2.5 to about 4.0 and a Dilution Index, Yd, of about −5.0 to about 7.0.

14-15. (canceled)

16. A process of making a flexible package having a sealed fitment, the process comprising heat sealing a fitment to a multilayer film to form the flexible package, wherein:
the multilayer film comprises:
a first skin layer comprising a high density polyethylene having a density of about 0.950 g/cm³ to about 0.970 g/cm³ and a melt index, I₂, of about 0.5 g/10 minutes to 10 g/10 minutes;
a core layer comprising polyethylene; and
a second skin layer comprising a sealant polyethylene having a molecular weight distribution Mw/Mn of 2 to 4, a density of 0.880 g/cm³ to 0.920 g/cm³, and a melt index, I₂, of 0.3 g/10 minutes to 5 g/10 minutes;
wherein the multilayer film is at least 90 wt. % polyethylene; and
the fitment comprises an ethylene-alpha-olefin co-polymer having a density of 0.880 g/cm³ to 0.910 g/cm³; and
the fitment is sealed to the second skin layer.

17. The process of claim 16, wherein the heat sealing comprises applying a heated pressure bar to the fitment at a pressure from about 15 psi to 50 psi, at a temperature of 140° C. to 180° C., and for a dwell time of less than 3 seconds.

18-19. (canceled)

20. A flexible package comprising:
a multilayer film comprising:
a first skin layer comprising a high density polyethylene having a density of about 0.950 g/cm³ to about 0.970 g/cm³ and a melt index, I₂, of about 0.5 g/10 minutes to 10 g/10 minutes;
a core layer comprising polyethylene; and
a second skin layer comprising a sealant polyethylene having a molecular weight distribution Mw/Mn of 2 to 4, a density of 0.880 g/cm³ to 0.920 g/cm³, and a melt index, I₂, of 0.3 g/10 minutes to 5 g/10 minutes;
wherein the multilayer film is at least 90 wt. % polyethylene; and
a fitment sealed to the second skin layer, the fitment comprising a blend of any two or more of a linear low density polyethylene, a very low density polyethylene, or a plastomer;
wherein the blend has a density of about 0.920 g/cm³ or less and a melt index, I₂, of about 5 g/10 minutes or greater.

21. The flexible package of claim 20, wherein the blend has a density of about 0.880 g/cm³ to about 0.920 g/cm³ and a melt index, I₂, of about 5 g/10 minutes to about 55 g/10 minutes.

22-23. (canceled)

24. The flexible package of claim 20, wherein the first skin layer comprises 85 wt. % to 100 wt. % of the high density polyethylene.

25. The flexible package of claim 20, wherein the second skin layer comprises 85 wt. % to 100 wt. % of the sealant polyethylene.

26-28. (canceled)

29. The flexible package of claim 20, wherein the fitment comprises at least 0.0015 parts per million of hafnium or titanium.

30. (canceled)

31. The flexible package of claim 20, wherein the fitment exhibits a flexural secant modulus of less than 30,000 psi.

32-36. (canceled)

37. The flexible package of claim 20, wherein the fitment comprises a blend of:
a linear low density polyethylene and one or more of a second linear low density polyethylene, a very low density polyethylene, and a plastomer.

38. A process of making a flexible package having a sealed fitment, the process comprising heat sealing a fitment to a multilayer film to form the flexible package, wherein:
the multilayer film comprises:
a first skin layer comprising a high density polyethylene having a density of about 0.950 g/cm³ to about 0.970 g/cm³ and a melt index, I₂, of about 0.5 g/10 minutes to 10 g/10 minutes;
a core layer comprising polyethylene; and
a second skin layer comprising a sealant polyethylene having a molecular weight distribution Mw/Mn of 2 to 4, a density of 0.880 g/cm³ to 0.920 g/cm³, and a melt index, I₂, of 0.3 g/10 minutes to 5 g/10 minutes;
wherein the multilayer film is at least 90 wt. % polyethylene; and
the fitment comprises a blend comprising any two or more of a linear low density polyethylene, a very low density polyethylene, and a plastomer;
wherein the blend has a density of about 0.920 g/cm³ or less and a melt index, I₂, of about 5 g/10 minutes or greater; and
the fitment is sealed to the second skin layer.

39. The process of claim 38, wherein the heat sealing comprises applying a heated pressure bar to the fitment at a pressure from about 15 psi to 50 psi, at a temperature of 120° C. to 180° C., for a dwell time of less than 3 seconds.

40-41. (canceled)

42. The process of claim 38, wherein the fitment comprises about 5 wt. % to about 50 wt. % of a very low density polyethylene and about 50 wt. % to about 95 wt. % of a linear low density polyethylene.

43. (canceled)
